(19) United States
(12) Patent Application Publication
(10) Pub. No.: US 2018/0170634 A1
(43) Pub. Date: Jun. 21, 2018

(54) MULTI-FUNCTION BOTTLE FOR LIQUID

(71) Applicant: JEREMY Lynn WOODRUFF, FAIRMONT, OK (US)

(72) Inventor: JEREMY Lynn WOODRUFF, FAIRMONT, OK (US)

(21) Appl. No.: 15/898,661

(22) Filed: Feb. 19, 2018

Related U.S. Application Data
(63) Continuation-in-part of application No. 15/362,833, filed on Nov. 29, 2016.

(51) Int. Cl. B65D 51/24; B65D 41/06; B23D 51/01; F41B 13/08

(52) U.S. Cl. CPC B65D 51/246; B65D 41/065; F41B 13/08; B23D 51/01; B65D 51/242

(57) ABSTRACT

A bottle for containing liquids having a cap portion and a liquid containing portion. The cap portion is removably attached to the liquid containing portion. A variety of tools may be removably attached to the cap portion.

### PRIORITY CLAIM

This is a continuation-in-part application that claims the benefit of the priority of U.S. patent application Ser. No. 15/362,833, titled “Patent Specification for TAC (Tactical Aid Canteen),” filed on Nov. 29, 2016, the contents of which are incorporated by reference herein.

### RELATED ART

### 1. Technical Field

The present invention relates to an apparatus for containing a liquid, and more particularly, to a bottle for liquid having a cap with added tools for functions that provide security, utensils, and comfort when in dangerous and/or remote environments.

### 2. Background

Bottle for liquid may be used as water bottles, or bottles for containing other types of liquid, such as for example, tea, coffee, juice, etc. It is to be understood that references to water bottles below shall encompass bottles for other types of liquid unless otherwise indicated.

Water bottles have become ubiquitous in many facets of daily life, such as for example, recreation, fitness, sports, hiking, any other activity in which proper hydration is important, or merely to have handy for hydration during the day regardless of the activity of the user. Water bottles provide an easy and important way to transport water in many environments and over great distances.

Oftentimes on a long hike or when a person travels a long distance with few resources including water, it may be important to minimize one's load while maybe having to take multiple water bottles to reduce the chance of running out. Multiple water bottles may also be needed when traveling in a group, or when a person desires to have different beverages on hand. The need to travel light may force a person to question whether certain tools that may be important.

### SUMMARY

In view of the above, a bottle for liquid is provided. In one aspect, a bottle for liquid comprises a liquid container portion having an opening at a top end of the liquid container. A bottle cap assembly configured to close the liquid container portion when positioned at the top end of the liquid container portion. The bottle cap assembly comprises a cap portion comprising a sealing mechanism configured to seal liquid in the liquid container portion when the cap portion is fitted on the top end of the liquid container portion. A tool includes a tool attachment mechanism to removably attach the tool to the cap portion. The tool is configured to perform one of a plurality of functions corresponding to a plurality of interchangeable tools configured for removable attachment to the cap portion.

Some examples of apparatuses for containing liquid are outlined above rather broadly in order that the detailed description thereof may be better understood, and in order that the present contribution to the art may be better appreciated. Additional example implementations of the devices, systems, and methods are described below and will form the subject matter of the claims appended hereto. In this respect, before explaining at least one example of the devices, systems, and methods in detail, it is to be understood that the devices, systems, and methods are not limited in their application to the details of construction or to the arrangements of the components set forth in the following description or illustrated in the drawings. Other example implementations of the devices, systems, and methods may be developed, practiced and carried out in various ways. Also, it is to be understood that the phraseology and terminology employed herein are for the purpose of the description and should not be regarded as limiting.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a front view of an example bottle for containing liquids with a transparent view of the liquid container portion of the bottle.

FIG. 2 is a front view of an example of a cap portion that may be used in an example bottle for containing liquid.

FIG. 3 is a side view of the bottle of FIG. 1.

FIG. 4A is a top view of an example of the cap portion of an example bottle.

FIG. 4B is a bottom view of an example of the cap portion of an example bottle.

FIG. 4C is a bottom view of an example of the liquid container portion of an example bottle.

FIG. 5 is a front view of an example of the liquid container portion of the bottle.

FIG. 6 is a perspective view of another example of a cap portion of a bottle.

FIG. 7 is a front view of an example of a cap portion that includes a removable saw attached thereto.

FIG. 8 is a front view of an example of a cap portion that includes a removable spork for use as an eating utensil attached thereto.

FIG. 9 is a front view of an example of a cap portion that includes a removable hook attached thereto.

FIG. 10 is a front view of an example of a cap portion that includes a removable fork attached thereto.

FIG. 11 is a front view of an example of a cap portion that includes another example of a removable rod attached thereto.

### DETAILED DESCRIPTION

### I. System Description

Disclosed herein are bottles for containing a liquid.

In an example implementation, a bottle includes a cap portion and a liquid container portion. The cap portion is configured to receive a removable attachments or tools. Such tools may include, for example, a rod usable for self-defense or other purposes, a double rod also usable for self-defense or other purposes, an eating utensil, a roasting prong, a spork for cooking, a saw blade, a hook, or other tools having a suitable attachment mechanism and a size that would allow the tool to fit in the liquid container portion. In use, a selected one of the removable tools may be attached to the cap portion and the bottle may be filled with a desired liquid, such as for example, water. The user may attach a different tool to other bottles and fill the other bottles with more water or different liquids. The user may thus be provided with a greater volume of water, or a variety of liquids to drink, without the need to pack the tools in their more conventional form. In this way, the user is provided with a way to more efficiently pack provisions for long trips to areas that may not be safe or have the typical resources needed for survival.

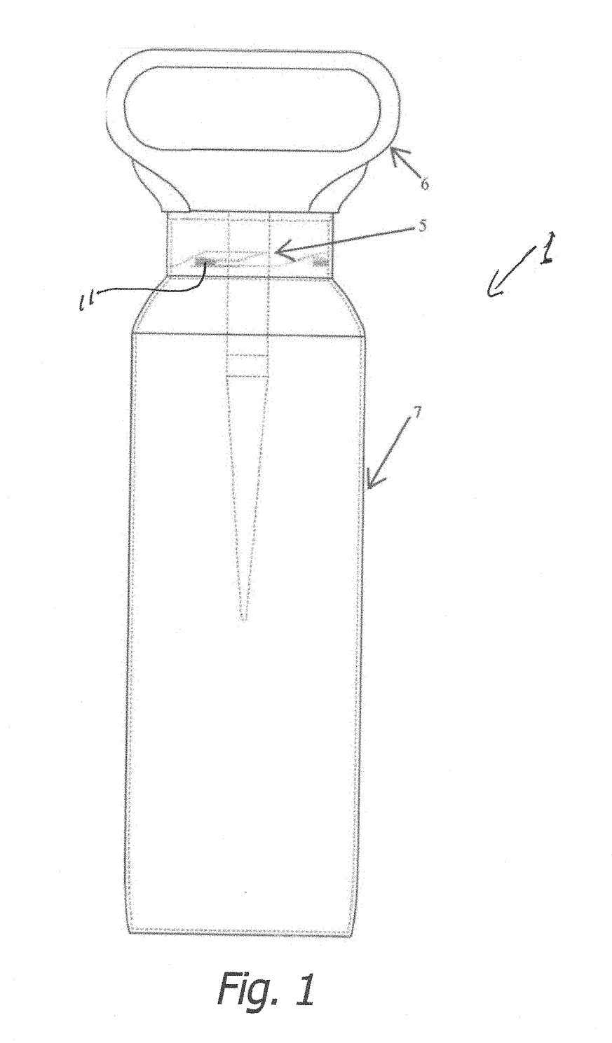

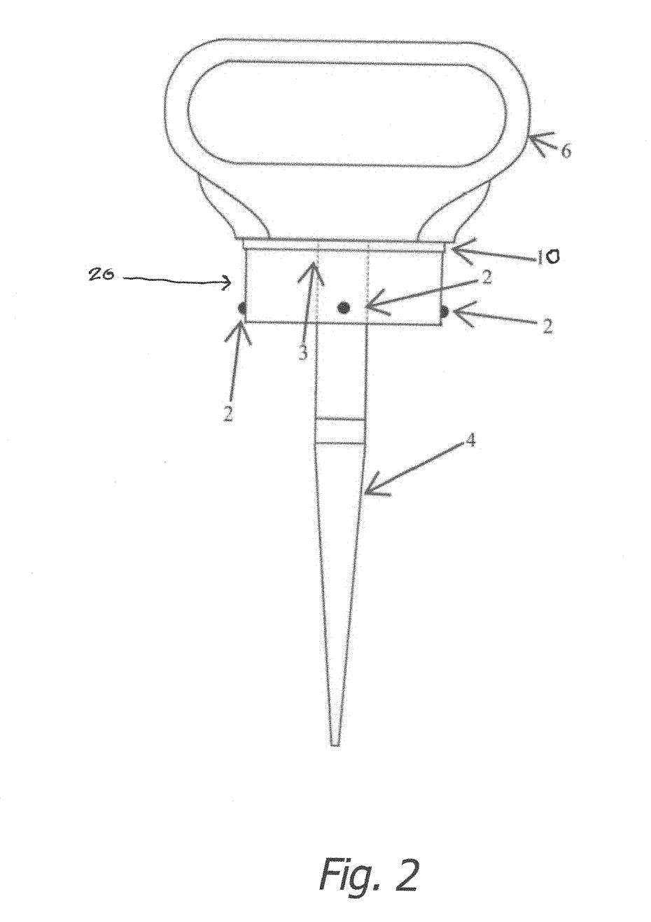

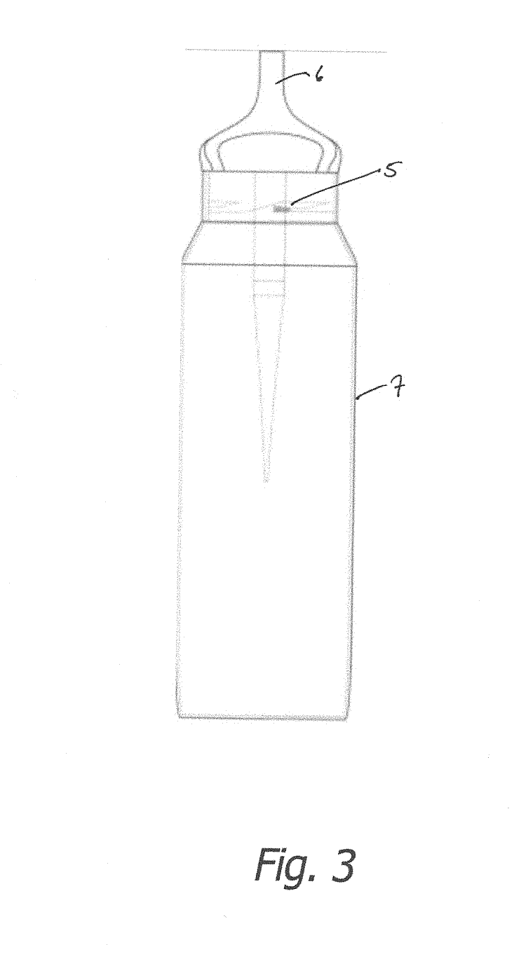

FIG. 1 is a front view of an example bottle 1 for containing liquids with a transparent view of a liquid container portion 7 of the bottle 1. FIG. 2 is a front view of an example of a cap portion 8 that may be used in an example bottle for containing liquid. FIG. 3 is a side view of the bottle 1 of FIG. 1.

Referring to FIGS. 1-3, the bottle 1 includes a liquid container portion 7 and a cap portion 8. The cap portion 8 includes a hand grip 6, which allows for easy access to the contents of the bottle 1. The cap portion 8 also includes a tool 4 attached via an attachment mechanism on a base portion 20 of the cap portion 8. The tool 4 in the example cap portion 8 in FIG. 2 is a prong that may be used for purposes of self-defense.

The cap portion 8 also includes a quick-release locking thread studs 2 (FIG. 2) in the base portion 20 configured to fit cooperatively with a quick-release locking bottle thread 5 on the liquid container portion 7 (FIG. 1) to provide a tight seal and fast removal of the cap portion 8 when either access to the tool or access to the liquid is needed. A rubber gasket 10 may be disposed above the quick-release locking thread studs 2 on the cap portion 8 to provide a seal that prevents liquid from leaking from the bottle 1. The attachment mechanism on the example cap portion 8 shown in FIG. 2 is a threaded tool hole 3. The threaded tool hole 3 may be configured to match a threaded end portion of the tool 4. The thread may be the same as that of a variety of tools that may thus be used interchangeably in the cap portion 8. The tool shown in FIGS. 1 and 2 is a detachable blunt point end rod 4 that may be used for safety or self-defense. Other tools include a double rod also usable for self-defense or other purposes, an eating utensil, a roasting prong, a spork for cooking, a saw blade, a hook, or other tools having a suitable attachment mechanism and a size that would allow the tool to fit in the liquid container portion, a double rod also usable for self-defense or other purposes, an eating utensil, a roasting prong, a spork for cooking, a saw blade, a hook, or other tools having a suitable attachment mechanism and a size that would allow the tool to fit in the liquid container portion. A variety of tools may be provided for safety, storage, purification, defense, survival, art, entertainment, creation, surveillance, power, and many more areas.

It is noted that the threaded tool hole 3 on the cap portion 8 and the threaded portion on the end of the tool provides for only one example of an attachment mechanism for interchangeable tools. Other attachment mechanisms may include a pressed fit using a nylon or plastic lining in the hole of the cap portion 8 where the tool 4 is maintained attached to the cap portion 8 by insertion into, and compression of, the plastic or nylon lined hole. Other attachment mechanisms include a magnetically charged tool end with an opposite magnetically charged hole in the cap wherein once the tool is inserted into the opposite magnetically charged hole in the cap the tool will be joined to the cap until an adequate force pulls the tool and cap apart. Other attachment mechanisms include a quick release three stud male tool end that adjoins to a female three groove hole in the cap, once the tool is rotated the three studs lock into the three groove holes in the cap.

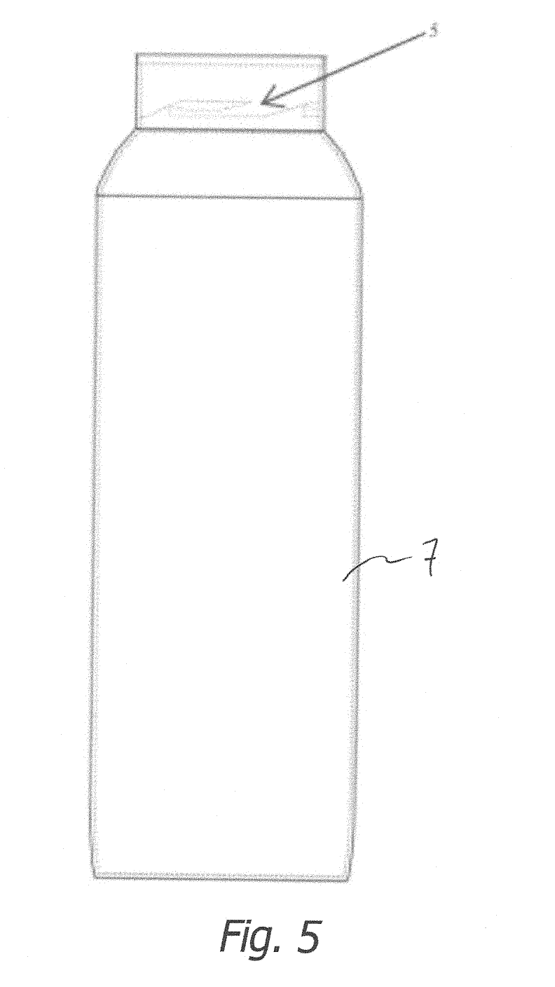

FIG. 5 is a side view of an example of the liquid container portion 7. The quick release locking bottle thread 5 is formed on the top of the liquid container portion 7 as shown in FIG. 5 as well as in FIG. 1. Referring to FIGS. 1, 2, and 5, the rubber gasket 10 on the cap portion 10 provides sufficient resistance when the cap portion 8 is attached to the liquid container portion 7 to keep the bottle 1 closed and leak free. The quick release stud 2 on the cap portion 8 are configured to slide into a fitted grove 11 at the end of the quick release bottle thread 5 (in FIGS. 1 and 5) to lock the cap portion 8 in place until the user decides to remove the cap portion 8 from the liquid container portion 7.

The cap portion 8 may be made of BPA-free plastic, aluminum, a food grade stainless steel, or other suitable materials. The liquid container portion 7 may also be made of BPA-free plastic, aluminum, a food grade stainless steel, or other suitable materials. The liquid container portion may also include structure that provides for thermal insulation to keep the contents either hot or cold or either.

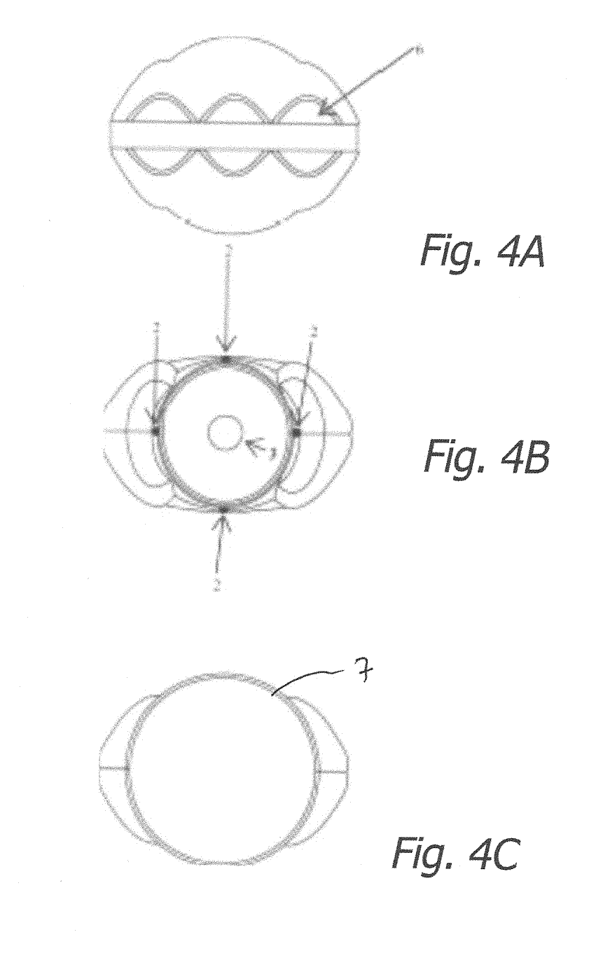

FIG. 4A is a top view of an example of the cap portion 8. FIG. 4B is a bottom view of the cap portion 8 in FIG. 4A. FIG. 4C is a bottom view of the liquid container portion 7 in FIG. 1. As shown in FIG. 4A, the cap portion 8 may include a hand grip 8 that may be configured for comfort while holding the bottle 1 or for ease of attachment and removal from the liquid container portion 7, or for ease of attachment and detachment of the tool 4. Another view of the quick-release studs 2 and the tool 4 are shown in FIG. 4B.

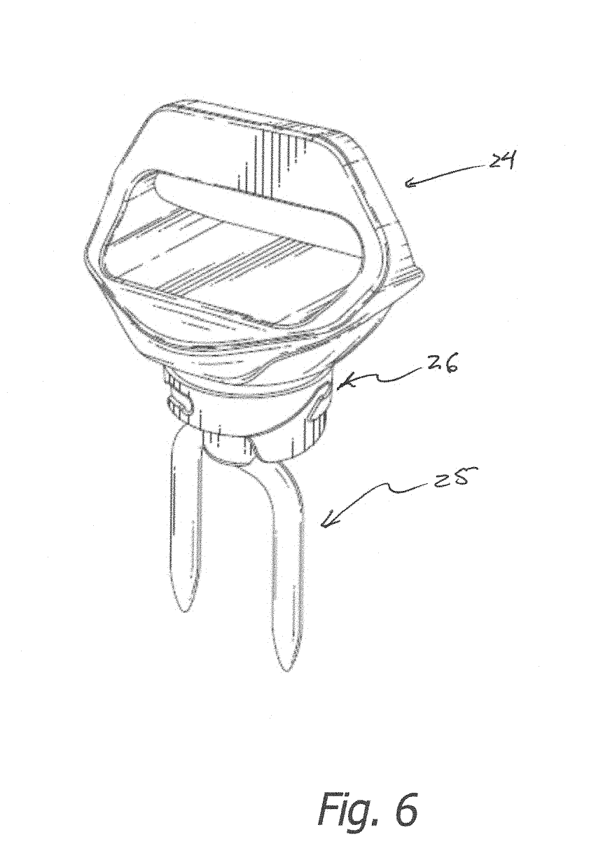

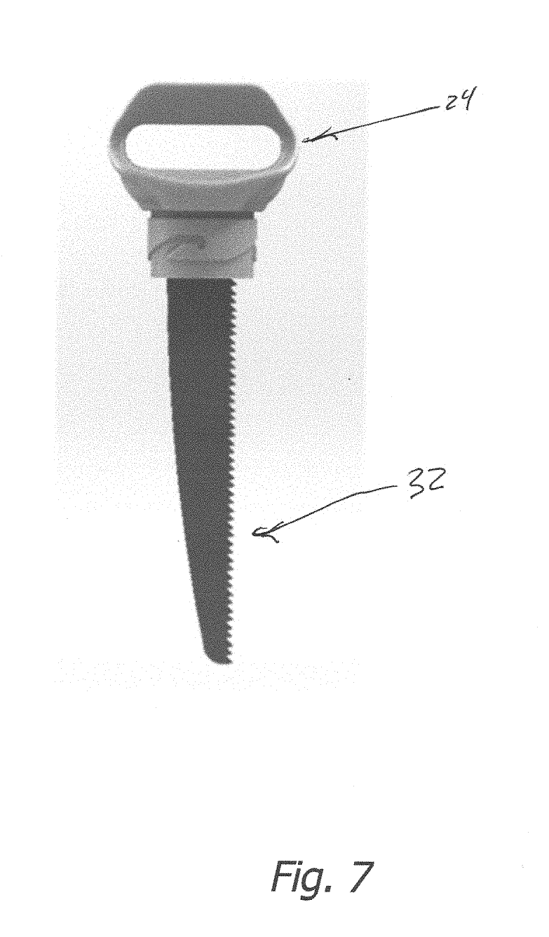

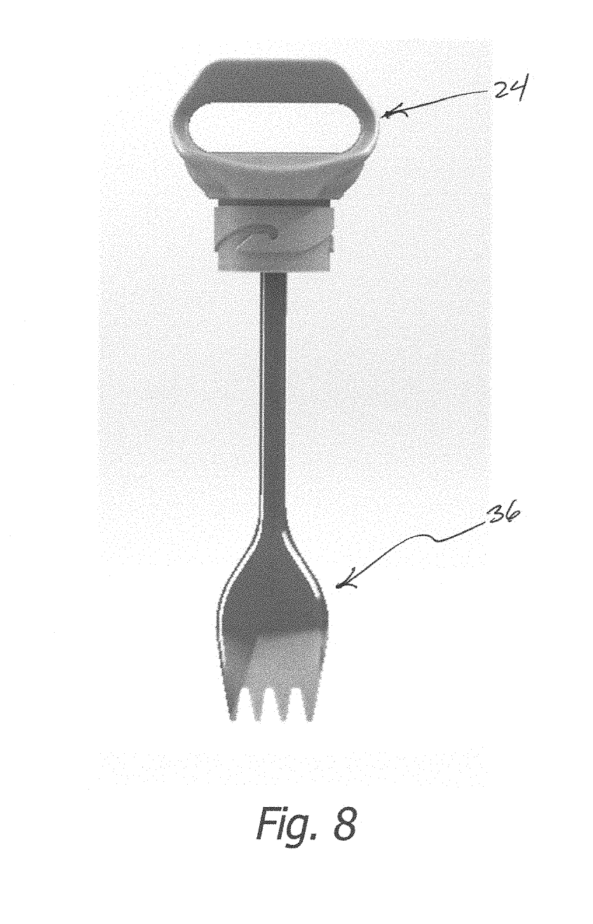

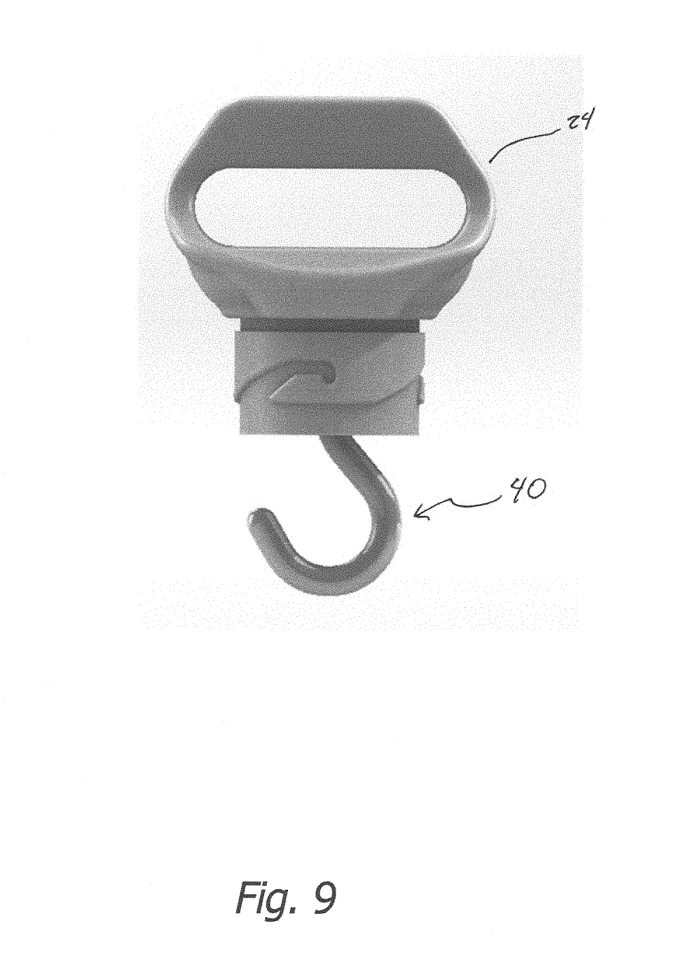

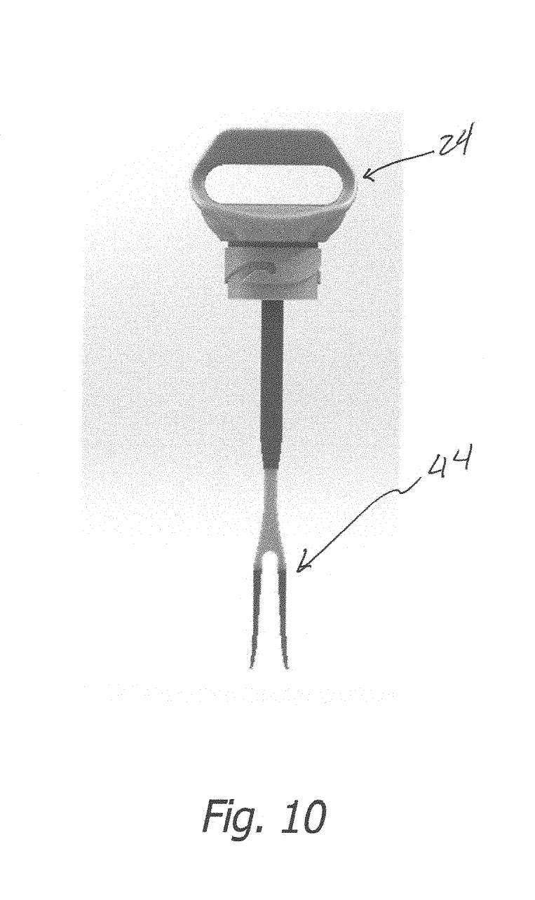

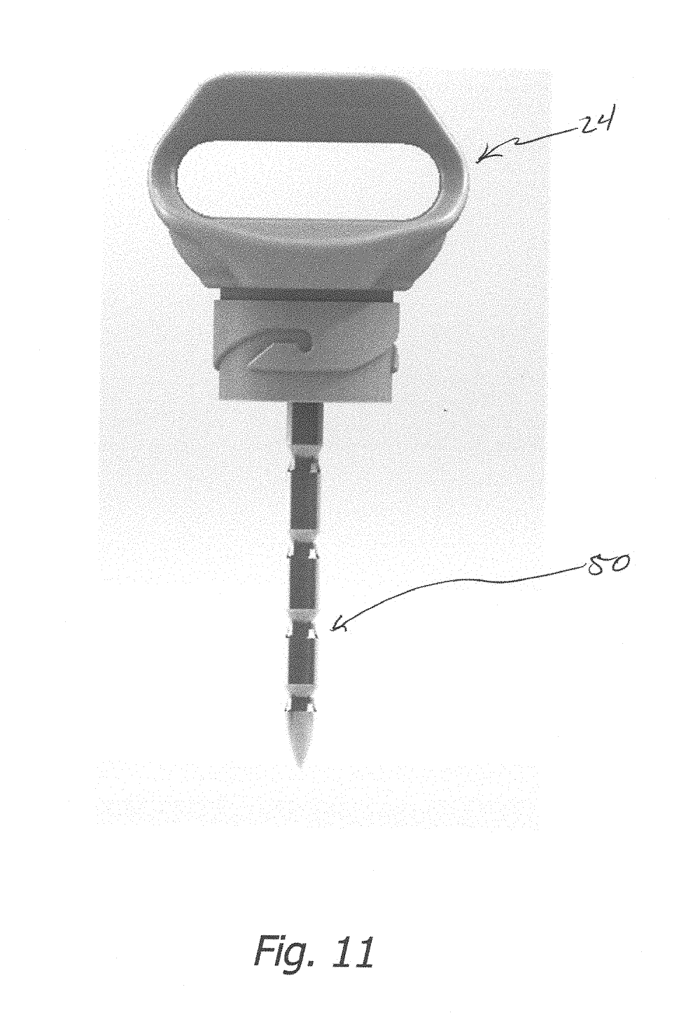

As noted above, the tool 4 may be any one of a variety of detachable tools that a user may find useful in harsh, scarce or unsafe environments. FIG. 6 shows a cap portion 24 fitted with a double prong 25, which may be used as a tool for self-defense or other purposes. It is noted that the cap portion 8 in FIG. 6 includes a quick-release thread and groove 26, for an attachment mechanism in which the quick-release studs are on the liquid container portion 7 (in FIG. 5). FIG. 7 shows the cap portion 24 in FIG. 6 fitted with a saw 32. FIG. 8 shows the cap portion 24 in FIG. 6 fitted with a spork 36. FIG. 9 shows the cap portion 24 in FIG. 6 fitted with a hook 40. FIG. 10 shows the cap portion 24 in FIG. 6 fitted with a fork 44. FIG. 11 shows the cap portion 24 in FIG. 6 fitted with another example of a prong 50. It is noted that the tools shown in FIGS. 6-11 are provided as examples of tools that may be configured to be removably attachable to the cap portion 8 or 24 of an example bottle 1.

Examples of the bottle 1 described above may be used according to the following steps:

First, the cap portion 8 or 24 is removed from the bottle 1. The blunt point end rod 4, or any other tool, such as any of the tools shown in FIGS. 6-11, is then attached to the threaded tool hole 3. The bottle is then filled with water or any other suitable liquid. The cap portion 8 or 24 is then screwed onto the liquid container portion 7.

The bottle 1 in the above figures may be used to drink liquid contained therein by removing the cap portion 8 or 24 from the bottle; pulling the cap portion 8 or 24 and attached tool 4 completely out of the bottle; and drinking from the bottle 1. Once the user is finished drinking, the cap portion with attached tool 4 is re-applied to the liquid container portion and the cap portion 8 is twisted thereon until it locks into place.

Other tools may be interchangeably attached to the cap portion 8 via the tool attachment mechanism on each tool. In the examples described above, the tool attachment mechanism includes the threaded tool hole 3 and the attachment of different tools may be accomplished by the following steps:

The cap portion is removed from the bottle. The cap portion 8 or 24 and tool 4 are removed completely from the bottle 1. The liquid container portion is set aside and the cap portion is firmly gripped while the tool 4 attached to the cap portion 8 is manually turned on the thread until it detaches from the threaded tool hole 3 on the tool 4. Another tool such as one of the tools in FIGS. 6-11, for example, may then be inserted onto the threaded tool hole 3 and turning the new tool until it is attached tightly and securely. The cap portion may then be placed back onto the bottle turning.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A bottle for liquid, the bottle comprising:
a liquid container portion having an opening at a top end of the liquid container; and
a bottle cap assembly configured to close the liquid container portion when positioned at the top end of the liquid container portion, the bottle cap assembly comprising:
a cap portion comprising an attachment mechanism configured to seal liquid in the liquid container portion when the cap portion is fitted on the top end of the liquid container portion; and
a tool comprising a tool attachment mechanism to removably attach the tool to the cap portion, the tool configured to one of a plurality of functions corresponding to a plurality of interchangeable tools configured for removable attachment to the cap portion.

2. The bottle of claim 1 where:
the tool is a device selected from the following devices:
a rod extending lengthwise from the tool attachment mechanism for use as a weapon for self-defense;
a pair of rods connected at one end and extending lengthwise from the tool attachment mechanism for use as a weapon for self-defense or for activities that would enable survival in the wilderness;
an eating utensil connected at one end and extending lengthwise from the tool attachment mechanism;
roasting prong for mounting a food item to be roasted;
a spork for use as an eating utensil;
a fork for use as an eating or cooking utensil;
a spoon for use as an eating utensil;
a saw blade for sawing branches of shrubbery or trees; and
a hook for pulling or hanging objects.

3. The bottle of claim 1 where the sealing mechanism on the cap portion includes a quick release locking thread stud configured to lock the cap portion in the top end of the liquid container portion.

4. The bottle of claim 1 where the attachment mechanism on the cap portion includes a quick release locking thread configured to lock the cap portion in the top end of a quick release locking stud formed on the liquid container portion.

5. The bottle of claim 1 where the attachment mechanism includes a bottle thread on the top end of the liquid container portion, where the cap portion includes a cap thread configured to receive the bottle thread.

6. The bottle of claim 1 where the attachment mechanism includes a rubber gasket to provide a liquid seal.

7. The bottle of claim 1 where the tool attachment mechanism includes a threaded tool hole on the cap portion to receive the tool via a threaded interference fit.

8. The bottle of claim 1 further comprising a handle grip attached to the cap portion to permit a grip of the cap portion.
